(19) United States
(12) Patent Application Publication
(10) Pub. No.: US 2002/0018079 A1
(43) Pub. Date: Feb. 14, 2002

(54) Method, program and device for creating content provided by internet-access service to information display device and computer-readable recording medium with content creating program recorded thereon

(76) Inventor: Takashi Onodera, Fukuoka-shi (JP)

Correspondence Address: BIRCH STEWART KOLASCH & BIRCH, PO BOX 747, FALLS CHURCH, VA, 22040-0747, US

(21) Appl. No.: 09/906,140

(22) Filed: Jul. 17, 2001

(30) Foreign Application Priority Data
Jul. 18, 2000 (JP) 2000-217743(P)

(51) Int. Cl. G06F 3/00

(52) U.S. Cl. 345/764

(57) ABSTRACT

A content creating method for creating content to be displayed on an information display device includes the steps of accepting an input source code of the content, storing the input source code, and displaying an image of a screen to be displayed on the information display device, the screen presenting the content provided by the stored source code. Accordingly, it is possible to input the source code of the content while the image of the screen which will be displayed on the information display device can be checked. Then, the content having an appropriate layout can readily be created based on the actually displayed image on the information display device.

### BACKGROUND OF THE INVENTION

1. Field of the Invention

The present invention relates to a content creating method, a content creating program, a computer-readable recording medium on which the content creating program is recorded, and a content creating device for creating content to be provided by an Internet-access service for information display devices.

2. Description of the Background Art

Cellular phone companies (carriers) now provide Internet-access services for cellular phones such as i-mode, EZweb, J-SKY (registered trademarks), and the like. The carriers accordingly offer information providing services to allow electronic mails to be sent and received on the Internet and allow information to be provided by means of WWW (World Wide Web). Content for a cellular phone supplied by the information providing service using WWW is presented on a small liquid crystal display of the cellular phone. Therefore, the content is described in a language somewhat different from the markup language namely HTML (Hyper Text Markup Language) which is used by the current Web sites. For example, markup languages like Compact HTML and HDML (Handheld Device Markup Language) are used respectively for i-mode and EZweb (registered trademarks).

When the content for the cellular phone is created by a personal computer (PC) or the like, an image of the content being created and presented on a larger display of the PC is not necessarily the same as that which will actually be presented on the smaller display of the cellular phone.

In particular, the liquid crystal display of the cellular phone can show approximately eight characters only in full size in the horizontal direction. Then, if the writing presented on the display is not divided appropriately into lines, the writing would considerably be difficult to see and understand.

### SUMMARY OF THE INVENTION

The present invention is made to overcome the problem above. One object of the invention is to provide a content creating method and a content creating device by which content having an appropriate layout can easily be created while an image of the content to be presented actually on a liquid crystal display of an information display device can be checked in the creation of the content.

Another object of the invention is to provide a computer-readable recording medium on which a content creating program is recorded by which content having an appropriate layout can be created by a computer while an image of the content to be presented actually on a liquid crystal display of an information display device can be checked in the creation of the content.

According to one aspect of the invention to achieve the above objects, a content creating method for creating content to be displayed on an information display device includes the steps of accepting an input source code of the content, storing the input source code, and displaying an image of a screen to be displayed on the information display device, the screen showing the content provided by the stored source code.

According to another aspect of the invention, a computer-readable recording medium has a content creating program recorded on the medium for creating, by a computer, content to be displayed on an information display device. The content creating program is used by the computer to perform the steps of accepting an input source code of the content, storing the input source code, and acquiring the stored source code to display an image of a screen to be displayed on the information display device, the screen showing the content provided by the source code.

According to still another aspect of the invention, a content creating device for creating content to be displayed on an information display device includes a source input unit for inputting a source code of the content, a source storage unit for storing the input source code, and a preview display unit for acquiring the stored source code and displaying an image of a screen to be displayed on the information display device, the screen showing the content provided by the source code.

According to a further aspect of the invention, a content creating method for creating content to be displayed on an information display device includes the step of outputting a screen including an input region and a display region adjacent to each other, the input region provided for inputting a source code of content and the display region provided for displaying the content provided by the input source code. The method further includes the steps of accepting the input source code of the content, updating the screen for displaying the content in the display region based on the input source code, and outputting the updated screen.

According to a still further aspect of the invention, a computer-readable recording medium having a content creating program recorded on the medium for creating content, by a computer, to be displayed on an information display device is used by the computer to perform the steps of outputting a screen including an input region and a display region adjacent to each other, the input region provided for inputting a source code of the content and the display region provided for displaying the content provided by the input source code, accepting the input source code of the content, updating the screen for displaying the content in the display region based on the input source code, and outputting the updated screen.

According to the present invention, the content creating method, the computer-readable recording medium on which the content creating program is recorded, and the content creating device can be provided by which a source code of content can be input while an image of a screen can be checked that shows the content and that will actually be presented on an information display device. The content having an appropriate layout can thus be created based on the image to be presented actually on the information display device.

According to a still further aspect of the invention, a content creating device for creating content to be displayed on an information display device includes a unit for outputting a screen including an input region and a display region adjacent to each other, the input region provided for inputting a source code of the content and the display region provided for displaying the content provided by the input source code, a unit for accepting the input source code of the content, a unit for updating the screen for displaying the content in the display region based on the input source code, and a unit for outputting the updated screen.

According to the present invention, the content creating method, the computer-readable recording medium on which the content creating program is recorded, and the content creating device can be provided by which a source code of content can be input while a display image of a screen can be checked that shows the content and that will actually be presented on an information display device. The content having an appropriate layout can thus be created based on the image to be presented actually on the information display device.

The foregoing and other objects, features, aspects and advantages of the present invention will become more apparent from the following detailed description of the present invention when taken in conjunction with the accompanying drawings.

### BRIEF DESCRIPTION OF THE DRAWINGS

FIG. 1 is a block diagram showing functions of a content creating device according to a first embodiment of the present invention.

FIG. 2 illustrates a structure of an operation screen of the content creating device in FIG. 1.

FIG. 3 illustrates a content management table.

FIG. 4 is a flowchart showing a procedure for creating content for cellular phones by the content creating device according to the first embodiment.

FIGS. 5 to 7 show specific examples of the operation screen shown in FIG. 2.

FIG. 8 schematically shows a structure of a content creating system according to a second embodiment.

FIG. 9 is a functional block diagram generally showing functions of a content creating device according to the second embodiment.

FIG. 10 is a flowchart showing a flow of process followed by the content creating device according to the second embodiment.

### DESCRIPTION OF THE PREFERRED EMBODIMENTS

Embodiments of the present invention are now described in conjunction with the drawings. It is noted that the same or corresponding components are denoted by the same reference character and description thereof is not repeated.

First Embodiment

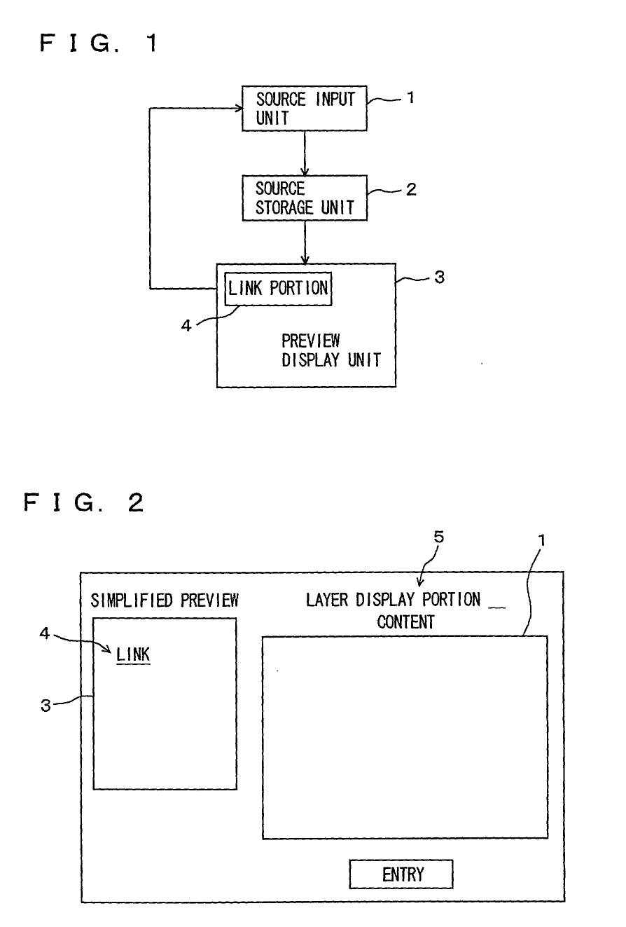

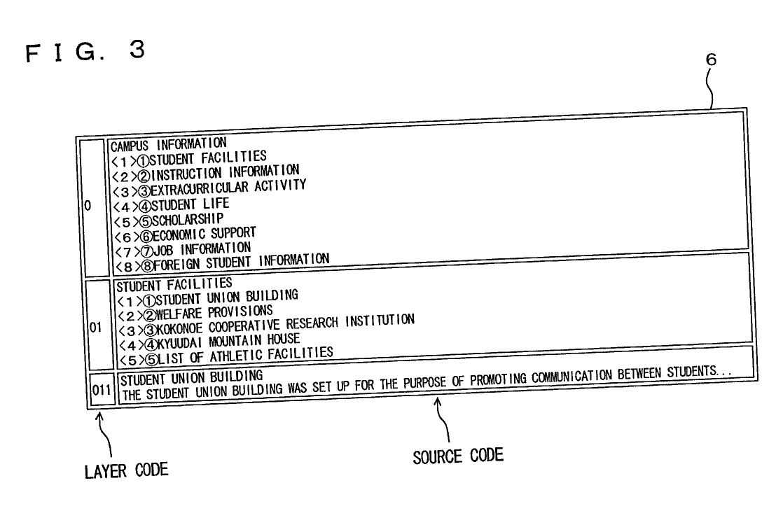

FIG. 1 is a block diagram showing functions of a content creating device according to a first embodiment of the present invention, and FIG. 2 illustrates a structure of an operation screen of the content creating device in FIG. 1.

According to the present invention, the content creating device creates content to be displayed on an information display device having an information display facility. Although the device having the information display facility in this embodiment is herein described as a cellular phone as an example thereof, the content created by the content creating device includes content to be displayed on an information terminal device with or without communication facility. The information terminal device having no communication facility can be connected to a communication device like cellular phone to display content received by the communication device.

The content creating device according to the first embodiment of the present invention includes components of a general personal computer such as an input unit like keyboard, mouse and the like, a display unit like liquid crystal display and the like, a reading unit for reading a program code and other data recorded on a recording medium like CD-ROM, and a central processing unit for controlling a storage device and other units each. The content creating device creates content to be provided by an Internet-access service for cellular phones.

Referring to FIG. 1, the content creating device includes respective functions of a source input unit 1 for entering a source code of content, a source storage unit 2 for storing the source code entered by source input unit 1, and a preview display unit 3 for acquiring the source code from source storage unit 2 to display a display image of a screen, which shows the content provided by the source code, to be presented on a cellular phone. As shown in FIG. 2, source input unit 1 and preview display unit 3 are formed on the display unit of the content creating device. Here, preview display unit 3 is arranged to be adjacent to source input unit 1 as shown in FIG. 2.

Source input unit 1 is provided for entering a source code which includes the content presented on the display of cellular phones. The source code is entered in the form of normal text data or text data by means of markup language such as Compact HTML and HDML including tags. The source code supplied to source input unit 1 is stored in source storage unit 2 by designating an “ENTRY” button shown in FIG. 2.

Preview display unit 3 acquires the source code from source storage unit 2, interprets the source code into an image of content which will be presented on a screen of a display of an actual cellular phone, and displays the image. If a link is set in the content displayed on preview display unit 3, a link portion 4 is formed in the image of content on preview display unit 3. If link portion 4 is designated, a window for creating another content to be linked with the content is shown. In addition, a layer display portion 5 indicating the layer of a link of content now being created is provided above source input unit 1.

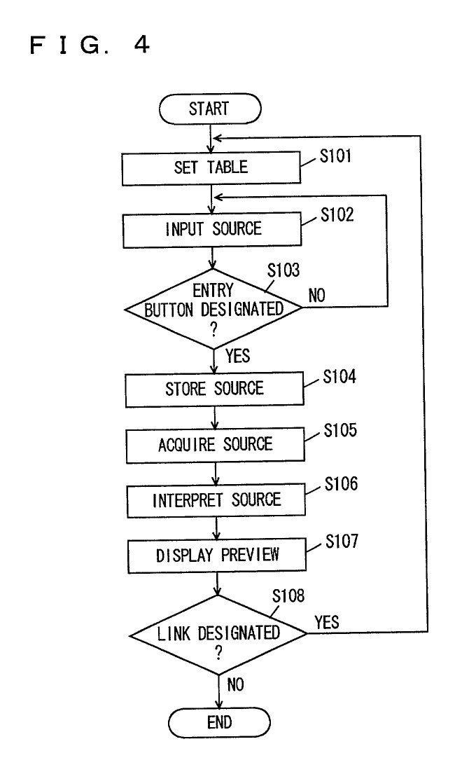

FIG. 3 illustrates a content management table 6 structured in source storage unit 2.

Source storage unit 2 includes content management table 6 shown in FIG. 3 that is set therein for managing contents to be created by using a code train including codes assigned successively in descending order of layers of contents, the highest layer being first. First, code “0” of the highest layer is set, and, when a source code for content of the highest layer is entered by source input unit 1, the source code is stored in a table of layer code “0”. Then, when a link for a subordinate layer relative to the content of the highest layer is set by link portion 4, code “1” is added next to code “0” of the parent layer and resultant code “01” is set accordingly. A source code for content thus linked is stored in a table of layer code “01”. In this way, source storage unit 2 is structured by content management table 6 which manages content according to the code train with codes assigned successively in descending order of content link layers.

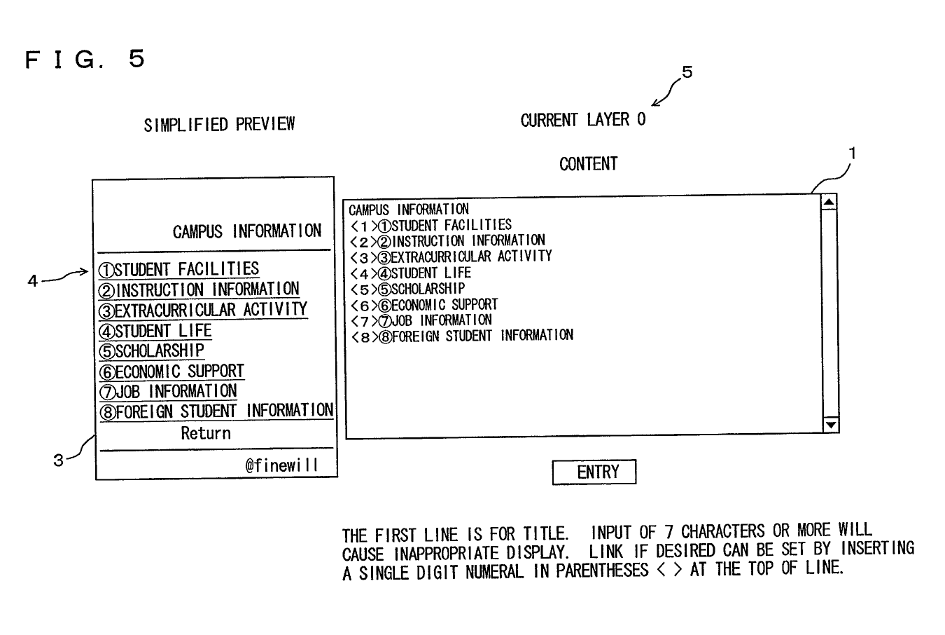

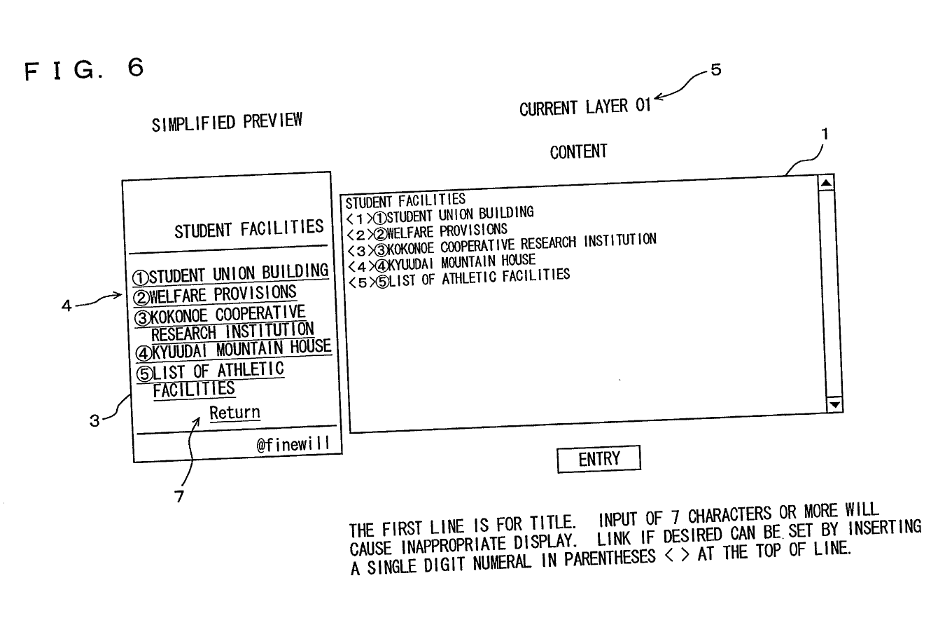

The content creating device having the above-described structure creates content for a cellular phone for example as explained below in conjunction with FIGS. 4 to 7. FIG. 4 is a flowchart showing a procedure for creating content for a cellular phone by the device according to this embodiment, and FIGS. 5 to 7 specifically show the operation screen shown in FIG. 2.

In step S101, layer code “0” for the highest layer of content to be created is set in content management table 6 shown in FIG. 3. In step S102, the content operation screen shown in FIG. 5 is presented on the display unit and a source code is input to source input unit 1 in the operation screen. In the example shown in FIG. 5, links are set relative to the source code and the links are set by means of numerals within the parentheses “<>”.

In step S103, the entry button shown in FIG. 5 is designated. Then, in step S104, the source code supplied to source input unit 1 is stored in source storage unit 2. The source code for the highest layer is stored in the table of layer code “0”.

In step S105, the source code of content is acquired from source storage unit 2. In step S106, the acquired source code is interpreted into an image to be presented on a screen of a display of an actual cellular phone. In step S107, the interpreted source code of content is presented on preview display unit 3 as the image to be displayed on the screen of the actual cellular phone. It is noted that, as links are set in step S102, link portion 4 is formed in the image presented on preview display unit 3. If the link portion 4 is designated, a window for creating other contents to be linked with this content is shown.

In step S108, when link portion 4 in preview display unit 3 shown in FIG. 5 is designated, the procedure returns to step S101 to add code “1” for this link portion 4 to layer code “0” of the parent layer, and resultant layer code “01” is set in content management table 6. Then, in step S102, a window is presented as shown in FIG. 6 for creating contents linked with the content of the parent layer. The content operation screen in FIG. 6 shows layer display portion 5 indicating layer code “01” of the link layer of content being created.

Content for layer code “01” is thereafter created through a similar procedure to that described above. When a further subordinate link is set, code “1” for link portion 4 is added to layer code “01” and resultant code “011” is set in content management table 6. Content in this layer can accordingly be created by means of the content operation screen shown in FIG. 7. In order to return to content of a higher layer, a link section 7 which is set as “RETURN” in preview display unit 3 shown in FIGS. 6 and 7 may be designated.

As discussed above, the content creating device of the first embodiment can be used to enter a source code for content into source input unit 1 by simultaneously checking an image of the content presented on preview display unit 3, the image being the one which will actually be displayed on a screen of a cellular phone. In this way, the content can readily be created that has a proper layout according to the image to be displayed actually on the cellular phone.

Moreover, since preview display unit 3 and source input unit 1 are adjacent to each other, an image of content to be displayed and a source code entered into source input unit 1 are displayed next to each other in one field of view. The source code of the content can thus be created easily while the image of the content to be displayed is being watched.

When another content to be linked with content presented on preview display unit 3 is created, link portion 4 provided in preview display unit 3 is used for proceeding to a screen for creating that another content through a similar procedure to that of an actual cellular phone. Then, it is possible to create linked content easily based on an actual manipulation of link on a cellular phone.

In source storage unit 2, content management table 6 is structured for managing content by means of a code train including codes assigned successively in descending order of layers of links of the content. Therefore, it is possible to flexibly adapt to different depths of layers or different layer structures of contents to be linked with each content, which is advantageous for creating content having a complex link structure.

The content creating device according to the first embodiment has effects as described below.

(1) There are provided the source input unit for entering a source code of content, the source storage unit for storing the entered source code, and the preview display unit for displaying an image of a screen, which shows the content provided by the source code, to be presented on a cellular phone. It is thus possible to input the source code of the content while the image of the screen to be displayed on the cellular phone can be checked, and accordingly the content can easily be created with a proper layout according to the actual screen displayed on the cellular phone.

(2) The arrangement of the preview display unit and the source input unit adjacent to each other allows the source code of content to be created easily while an image of the content to be displayed can be checked in the same field of view.

(3) The preview display unit showing an image of content to be displayed includes the link portion which is used for creating another content linked with that content. Therefore, the linked content can readily be created according to manipulation of link on an actual cellular phone.

(4) The source storage unit is structured by the table which manages content by means of a code train with codes assigned successively in descending order of layers of links of content. It is thus possible to adapt flexibly to different depths of layers or different layer structures of contents to be linked with each other, which is suitable for creation of content having a complicated link structure.

Moreover, the content creating device according to the present invention is applicable to a client server system connected to a PC via a network such as the Internet. The present invention applied to the client server system is described below.

Second Embodiment

According to a second embodiment, a content creating device functions as a server of a client server system. Content creating device 100 is implemented by means of a personal computer (PC) or workstation, while a PC functions as a client. The content creating device as a server and the PC as a client transmit and receive markup language such as HTML and the like and accordingly the content creating device creates content.

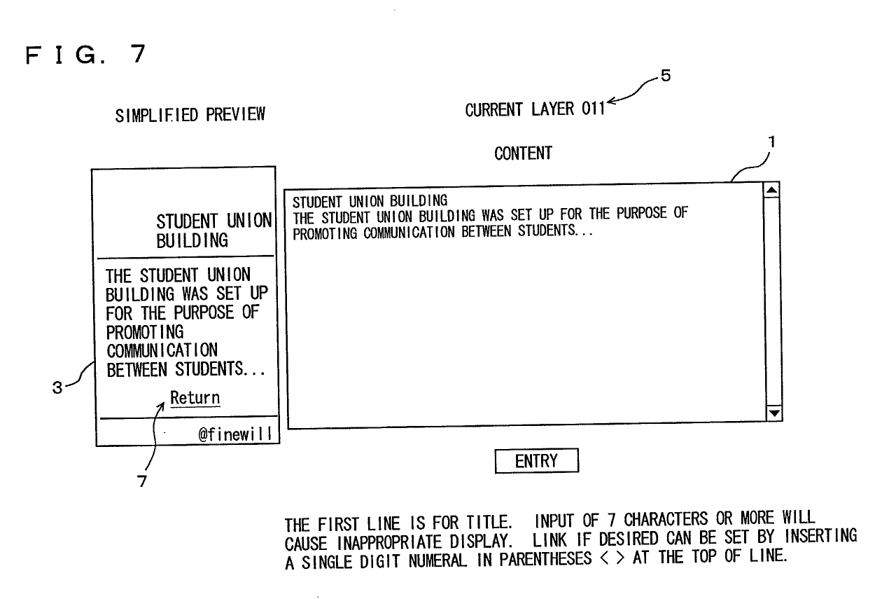

FIG. 8 schematically shows a structure of a content creating system according to the second embodiment. Referring to FIG. 8, the content creating system is constituted of content creating device 100, an external storage device 102 connected to content creating device 100, and personal computers 101A and 101B (hereinafter referred to as “PC101A” and “PC101B” respectively). Content creating device 100 and PC101A and PC 10lB are connected to the Internet 105. Content creating device 100 can thus transmit and receive markup language like HTML to and from PC101A or PC101B.

Although the Internet 105 is employed in this embodiment as a network, local area network, public circuit and the like may alternatively be employed instead of the Internet.

Content creating device 100 is connected to external storage device 102. External storage device 102 reads a program and data recorded on a computer-readable recording medium 103 and transmits the read program and data to content creating device 100. According to an instruction from content creating device 100, necessary data is written onto computerreadable recording medium 103.

Computer-readable recording medium 103 is any medium which fixedly holds a program, such as tape media like magnetic tape and cassette tape, disk media like magnetic disk (flexible disk, hard disk and the like) and optical disk (CD-ROM/MO/MS/DVD and the like), card media like IC card (including memory card) and optical card, and semiconductor memories like mask ROM, EPROM and flash memory. Alternatively, recording medium 103 may be any medium which transports a program to allow the program to be downloaded from a network. External storage device 102 is structured as a device capable of writing data or reading data onto or from such a recording medium 103.

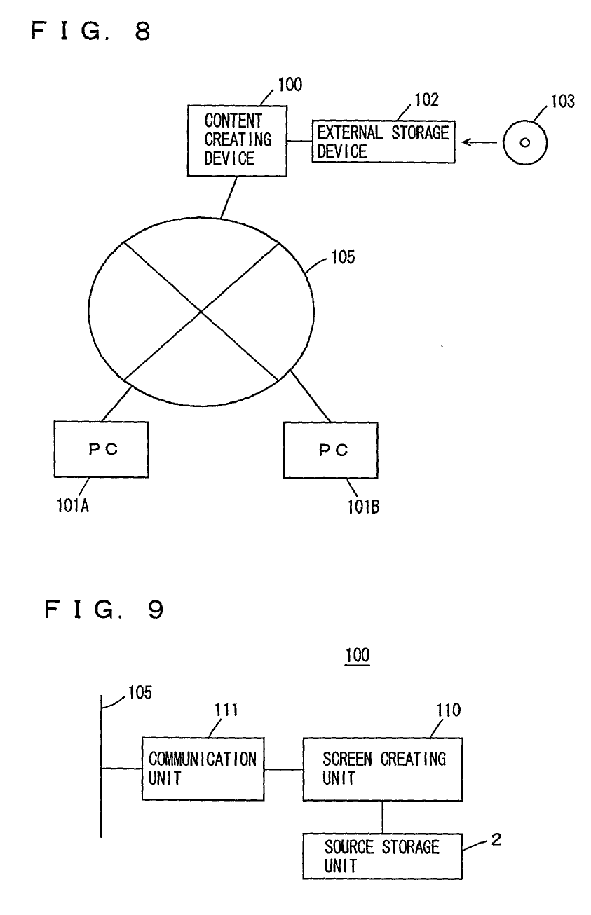

FIG. 9 is a functional block diagram generally showing functions of content creating device 100 according to the second embodiment. Referring to FIG. 9, content creating device 100 includes a communication unit 111 for connecting content creating device 100 to the Internet 105, a screen creating unit 110 connected to communication unit 111, and a source storage unit 2 connected to screen creating unit 110.

Communication unit 111 is an interface for connecting content creating device 100 to the Internet. Screen creating unit 110 controls the entire content creating device 100 while it reads a source code stored in source storage unit 2 to create a screen to be presented on a display of PC101A. This screen is created by means of markup language like HTML as data transmitted to PC101A and PC101B.

Source storage unit 2 stores a source code supplied from PC101A and PC101B via communication unit 111. The source code can contain content and link information that will be presented on a display unit of an information display device and the like. The link information is provided for linking the content included in the source code to other contents as detailed later.

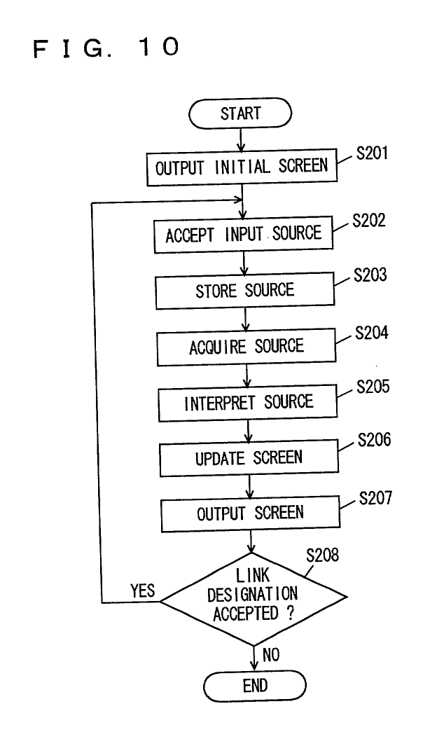

FIG. 10 is a flowchart showing a flow of process followed by content creating device 100 according to the second embodiment. Here, for the purpose of facilitating understanding of the description, an example is given in which PC101A makes an access for creating content. Then, content creating device 100 and PC101A transmit and receive markup language like HTML.

Referring to FIG. 10, content creating device 100 outputs, in response to an instruction from PC101A, an initial screen onto PC101A via communication unit 111 (step S201). The output initial screen output is the operation screen as shown in FIG. 2. The initial screen includes a source input unit 1 as a region for entering a source code and a preview display unit 3 as a region for displaying content corresponding to the entered source code, source input unit 1 and preview display unit 3 being arranged to be adjacent to each other. Preview display unit 3 has its width which is almost equal to that of a screen of an information display device. On preview display unit 3, content is displayed in a similar form to that of content displayed on a display unit of the information display device, i.e., the number of displayable characters is the same for both of preview display unit 3 and the display unit of the information display device. Although link portion 4 is shown in FIG. 2, the initial screen includes no link portion 4. In other words, nothing is displayed on source input unit 1 and preview display unit 3 of the initial screen.

PC101A receives the initial screen transmitted thereto to present the screen on the display of PC10lA. In actual, the initial screen is described in markup language like HTML and accordingly PC101A interprets the markup language by its browser software to show the interpreted language on the display.

A user of PC101A can watch the initial screen on the display to enter a source code into source input unit 1 by a keyboard, mouse and the like. After the input of the source code to source input unit 1, the user designates “ENTRY” button to transmit the input source code to content creating device 100.

Content creating device 100 then receives the source code from PC101A to accept the input source code (step S202).

After the input source code is accepted, the input source code is stored in source storage unit 2 (step S203). Source storage unit 2 has a content management table 6. Content management table 6 associates a layer code with a source code and stores these codes.

The layer code is a code train having codes assigned successively in descending order of layers of content. A layer code for the highest layer is represented by a code train with a single digit to which assigned “0”associated with a source code of the highest layer. There is a single source code for the highest layer.

Each time the layer of the source code descends by one, the original higher layer code is carried and a code is added as the one place. For example, a layer code associated with a source code of the second layer has two digits and a layer code associated with a source code of the third layer has three digits. The number of digits of a layer code thus represents the depth of the layer and a code of each digit of the layer code represents a source code of a layer associated with that digit.

In this way, the layer code specifies a source code. For example, layer code “01” specifies the first source code of the second layer, and layer code “05” specifies the fifth source code of the second layer. In the case of layer code “015”, “01” represents the first source code of the second layer and “5” in the one place represents the fifth source code of the third layer and thus layer code “015” specifies the fifth source code of the third layer which corresponds to the first source code of the second layer.

The content management table thus associates a layer code with a source code, the layer code defined by a code train having codes assigned successively in descending order of layers.

Referring back to FIG. 10, in the following step S204, the source code stored in source storage unit 2 is read by screen creating unit 110. At this time, the read source code is the one stored in content management table 6 that is associated with a designated layer code. In step S204, the layer code is designated. When the source code is stored in step S203, the layer code is associated with the source code. Then, in step S204, the layer code associated with the source code in step S203 is designated. When link designation is accepted in step S208 discussed below, a layer code defined by the link designation is designated.

In step S205, the source code is interpreted. The source code can include content and link information. If the source code includes link information, a link portion is generated to designate a source code linked with the source code.

Specifically, if the read source code includes link information, a layer code corresponding to the link information is determined. A relation between the link information and layer code is now described by means of source codes and layer codes stored in content management table 6 shown in FIG. 3. Referring to FIG. 3, numerals in parentheses “<>” represent link information. For example, a source code associated with layer code “0” includes link information “1” and associated content “student facilities” in one line. Layer code “0” and link information “1” indicates that there are links to a source code associated with layer code “01”. In this way, the layer code and link information specifies a layer code lower than that layer code by one layer.

A layer code associated with a source code and link information included in the source code specify another layer code. According to the relation between the layer code and link information, the link portion issues a command for calling another source code associated to that another layer code.

Referring again to FIG. 10, in the following step S206, the screen which has already been transmitted to PC101A is updated to a screen for showing, on preview display unit 3, content and a link portion obtained by interpreting the source code in step S205. This screen is described in markup language like HTML. The updated screen includes the link portion if the source code includes link information.

In step S207, the screen updated in step S206 is output onto PC 101A. PC101A receives the screen to present on its display a screen for example shown in FIG. 5. The screen shown in FIG. 5 is the one updated from the initial screen based on the source code of layer code “0” in content management table 6 in FIG. 3.

Referring to FIG. 5, the source code associated with layer code “0” and stored in content management table 6 in FIG. 3 is directly shown on source input unit 1. On preview display unit 3, content of the source code is shown except for link information, “<” and “>”. Additionally, characters “RETURN” are presented under the content.

Lines of the content with respective underlines represent link portion 4. The link portion includes a command for designating a layer code associated with another content linked with the content shown therein.

When a user of PC101A designates link portion 4 by a pointing device like mouse, a command is transmitted to content creating device 100 for calling a source code specified by the designated link portion 4. The command includes a layer code associated with the source code specified by link portion 4.

Link portion 4 is thus designated and accordingly the command is transmitted to content creating device 100, and then content creating device 100 accepts the link designation (step S208).

When the link designation is accepted, the layer code included in the transmitted command is newly created in content management table 6 and input of an associated source code is accepted in step S202. If the source code associated with the layer code contained in the received command has already been stored in content management table 6, the stored source code is read and the step S202 is then carried out.

If no link designation is accepted in step S208, the process is completed.

Referring to FIG. 5, preview display unit 3 shows, under the displayed content, a link section represented by characters “RETURN” which represents a link to a source code in a layer higher by one layer than the displayed layer.

As detailed above, the content creating system according to the second embodiment transmits a screen, to PC101A, including source input unit 1 and preview display unit 3 adjacent to each other, source input unit 1 being provided for entering a source code of content and preview display unit 3 being provided for presenting an image of content included in the entered source code that will actually be displayed on a screen of an information display device. Accordingly, a user of PC101A can input a source code while checking an image thereof to be displayed actually on the screen of the information display device. The user can thus create content having a layout appropriate for displaying the content on the information display device.

The screen transmitted to PC101A and presented on the display thereof has source input unit 1 and preview display unit 3 adjacent to each other. A user of PC101A can input a source code while checking the image thereof to be displayed actually on the screen of the information display device.

Preview display unit 3 presented on the display of PC101A includes link portion 4. Therefore, a user of PC101A can change display on preview display unit 3 by designating link portion 4 through a similar procedure to that for changing display on an information display device. Moreover, the user can update or newly create a source code displayed on the changed preview display unit 3 that the user is watching.

Source storage unit 2 stores a code train and a source code associated with each other in content management table 6, the code train having codes assigned in descending order of layers of links, the highest layer being first. Then, it is possible to adapt flexibly to different depths of layers or different layer structures of contents to be linked with each content, which is suitable for creation of content having a complicated link structure.

The content creating device according to the present invention is implemented for example by a personal computer or workstation. A content creating program for implementing functions of the content creating device is recorded on a computer-readable recording medium such as semiconductor memory, hard disk, CD-ROM, floppy (registered) disk, or magneto-optical disk. The program recorded on the recording medium is loaded at any appropriate time onto a main memory and performed by a processing unit. At this time, any driver is used as required such as CD-ROM drive, floppy disk drive or magneto-optical disk drive. If the recording medium is provided in a server connected by a communication line like a network, the program is read or downloaded from the server via the communication line. If the program is transferred to the processing unit via the communication line, the communication itself corresponds to the recording medium. The program can be supplied to operate in various operating systems (OS), platform, system environment or network environment.

The content creating device according to the present invention can be implemented by supplying a recording medium having such software program code recorded thereon to a system or device to allow a computer (or CPU, MPU or the like) of such a system or device to read and execute the program code recorded on the recording medium.

Although the present invention has been described and illustrated in detail, it is clearly understood that the same is by way of illustration and example only and is not to be taken by way of limitation, the spirit and scope of the present invention being limited only by the terms of the appended claims.

What is claimed is:

1. A content creating method for creating content to be displayed on an information display device, comprising the steps of:
accepting an input source code of said content;
storing said input source code; and
displaying an image of a screen to be displayed on said information display device, said screen showing said content provided by said stored source code.

2. The content creating method according to claim 1, wherein
said step of displaying includes the step of displaying said image of the screen to be displayed on said information display device in a region adjacent to a region where said source code is input.

3. The content creating method according to claim 1, wherein
said step of displaying includes the step of displaying a link portion for creating another content linked with said content in the displayed image of said content.

4. The content creating method according to claim 3, wherein
said step of storing includes the step of storing a code train associated with said content, said code train including codes assigned successively in descending order of layers of links of said content.

5. A computer-readable recording medium having a content creating program recorded on said medium for creating, by a computer, content to be displayed on an information display device,
said content creating program used by said computer to perform the steps of
accepting an input source code of said content,
storing said input source code, and
acquiring said stored source code to display an image of a screen to be displayed on said information display device, said screen showing said content provided by said source code.

6. A content creating device for creating content to be displayed on an information display device, comprising:
a source input unit for inputting a source code of said content;
a source storage unit for storing said input source code; and
a preview display unit for acquiring said stored source code and displaying an image of a screen to be displayed on said information display device, said screen showing said content provided by said source code.

7. A content creating method for creating content to be displayed on an information display device, comprising the steps of:
outputting a screen including an input region and a display region adjacent to each other, said input region provided for inputting a source code of said content and said display region provided for displaying said content provided by said input source code;
accepting said input source code of the content;
updating said screen for displaying said content in said display region based on said input source code; and
outputting said updated screen.

8. The content creating method according to claim 7, wherein
said updating step includes, when said source code includes link information for linking said content to another content, the step of incorporating a link portion into said display region for inputting an instruction to change the content displayed in said display region to said another content.

9. The content creating method according to claim 7, wherein
said content has a layered structure defined by said link information, and
said content creating method further includes the step of storing said source code associated with a code train assigned according to said layered structure.

10. A computer-readable recording medium having a content creating program recorded on said medium for creating, by a computer, content to be displayed on an information display device, said content creating program used by said computer to perform the steps of
outputting a screen including an input region and a display region adjacent to each other, said input region provided for inputting a source code of said content and said display region provided for displaying said content provided by said input source code,
accepting said input source code of the content,
updating said screen for displaying said content in said display region based on said input source code, and
outputting said updated screen.

11. A content creating device for creating content to be displayed on an information display device, comprising:
means for outputting a screen including an input region and a display region adjacent to each other, said input region provided for inputting a source code of said content and said display region provided for displaying said content provided by said input source code;
means for accepting said input source code of the content;
means for updating said screen for displaying said content in said display region based on said input source code; and
means for outputting said updated screen.
